(19) United States
(12) Patent Application Publication
(10) Pub. No.: US 2012/0185127 A1
(43) Pub. Date: Jul. 19, 2012

(54) ELECTRIC EMISSION WHEEL ASSEMBLY

(75) Inventor: Orlando Da Mota PAVAN, Sao Paulo (ES)

(73) Assignee: SABO INDUSTRIA E COMERCIO DE AUTOPECAS LTDA, Sao Paulo (BR)

(21) Appl. No.: 13/209,962

(22) Filed: Aug. 15, 2011

(30) Foreign Application Priority Data
Aug. 13, 2010 (ES) PI 1.002.984-2-0

(51) Int. Cl. G01M 17/00

(52) U.S. Cl. 701/34.4

(57) ABSTRACT

This invention patent is related to an electric emitting wheel assembly (1), belonging to the electronic component field used in the automotive industry, which was developed to identify or monitor parameters of the rotating part (100) such the crankshaft or others. This assembly is made of: the sensitizing ring (2) (tone wheel) of electric material conducting, mounted electrically insulated around the rotating part (100), connected to an external voltage supply, suitable for generating and temporarily storing in the Gauss surface of the ring (2), an electric field (40). This sensitizing ring (2) also has a commutation strip (5) selected to emit an electric field (40) with regular intermittency, generating the specific intermittent electric field (40)′. The sensor capacitive (30), reads the specific intermittent electric field (40).

### CROSS-REFERENCE TO RELATED APPLICATION

This application claims the priority of Brazilian Application No. PI 1.002.984-2-0, filed Aug. 13, 2010, the entire specification, claims and drawings of which are incorporated herewith by reference.

### INTRODUCTION

This present invention relates to a wheel assembly or sensitizing ring and capacitive sensor, belonging to the automotive and associated industry field which was developed for situations that needed a sensitizing element to identify or monitor rotations, positions, angles, speeds and other parameters of a rotating part.

### STATE OF THE ART

Countless devices have rotating parts, such as axles and others which need to have their rotation system monitored and identified so that the functioning occurs within the intended parameters and/or serve other purposes. For this, these rotating parts are associated with sensor assemblies, normally essentially consisting of: mounted sensitizing device(s) around the rotating part; sensor device(s) appropriately mounted next to the sensitizing device(s); means of sensitization, as for example, magnetic fields generated for example, sensitizing device(s) that sensitize the sensor(s) which once sensitized are commuted and generate signal(s); and dedicated purpose built electronic circuit to process the signal(s) generated.

Assemblies of this type are in common use in the automotive industry, which occurs, for example in electronic injection systems, to monitor the crankshaft position, fundamental for the management and good functioning of the engine, generating less fuel consumption, less quantity of emissions into the environment, less noise intensity and others. For this purpose Hall Effect or AMR or GMIR magnetic sensors are normally used. However, one of the restrictions of this hall sensor component for automotive uses is the high cost.

Bearing in mind this situation and seeking to reduce cost, the possibility of obtaining a capacitive sensor was researched, which would serve for this use and would have a lower cost. However, the technological challenge was to develop a special sensitizing ring to emit an electric signal known also as an electric field, which the capacitive sensor was capable of collecting and recognizing, and in this way be different from the capacitive sensor technology already known on the market.

The patent application, with the provisional protocol number PI 018100007784, called “Wheel Emitting Assembly”, of the same application, presents a solution whose electric field is obtained by a dielectric, in which the molecules align themselves forming permanent electric dipoles and/or induction of a surface charge due to the polarization of an external electric field. This energy stored is the “source” necessary to sensitize the capacitive sensor.

One of the constructive characteristics of this solution is the use of a special dielectric film on a metallic tone wheel and the provision of an electric induction process of this dielectric film which is made by special ionization processes or electric discharge processes in contact with the substrate.

Despite good results obtained with the application solution mentioned above, the studies have continued seeking to obtain new advantageous solutions for the application.

Therefore, an objective of this invention is to provide a wheel assembly or sensitizing ring of a capacitive sensor of the type whose sensitizing element is an electric field which is used to identify and/or monitor parameters such as: speed, acceleration, rotations, positions, angles and others of a rotating part, particularly for the automotive industry, which is efficient and simple to make in relation to the usual ones.

The other objective is to provide a wheel or sensitizing ring and capacitive sensor assembly for the above use, which is cheaper relative to the others.

### INVENTION DESCRIPTION SUMMARY

One of the main physical objectives is to discover simple ways to resolve apparently complex problems. Therefore analyzing the Gauss law, it can be verified that an insulating conductor material has charge conducting characteristics on its surface forming a Gauss surface. This Gauss surface is a temporary electric field (not permanent) which verified, can sensitize a capacitive sensor.

Using this knowledge in this case, verifying if a sensitizing wheel or ring can be built incorporating a Gauss surface, thereby making unnecessary, a dielectric material covering of a wheel or ring which under an external electric field polarizes and maintains a permanent charge. One advantage of this development relating to patent application PI 018100007784, is, therefore, the elimination of the use of a special dielectric film on a metallic tone wheel and also the elimination of the electric induction process of this dielectric film which is made by special ionization processes or electric discharge processes in contact with the substrate.

Therefore, the big advantage of this solution is the facility of industrially producing this new assembly device of a wheel emission sensitizing of the capacitive sensor assembly device. The advantage was to achieve by the concepts of physics find a commercially viable technical solution to resolve an apparently complex problem. Furthermore, this solution lowers the construction cost, conforming to the other invention objective.

### REGARDING THE FIGURES

The attached drawings refer to the electric emission wheel assembly, the objective of this patent, in which:

FIG. 1 shows a generic scheme of a tone wheel and sensor assembly mounted on a shaft to be monitored;

FIG. 2 shows an illustrative scheme of an experiment conducted to study the electric fields on a metallic plate;

FIG. 3 shows a schematic detail of the first version of the invention;

FIG. 4 shows a schematic detail of the second version of the invention;

FIGS. 5, 5a and 5b show a schematic detail of the third version of the invention and the indication of functioning; and

FIGS. 6, 6a and 6b show a schematic detail of two constructions and a fourth version of the invention.

### DETAILED DESCRIPTION OF THE INVENTION BASED ON THE FIGURES

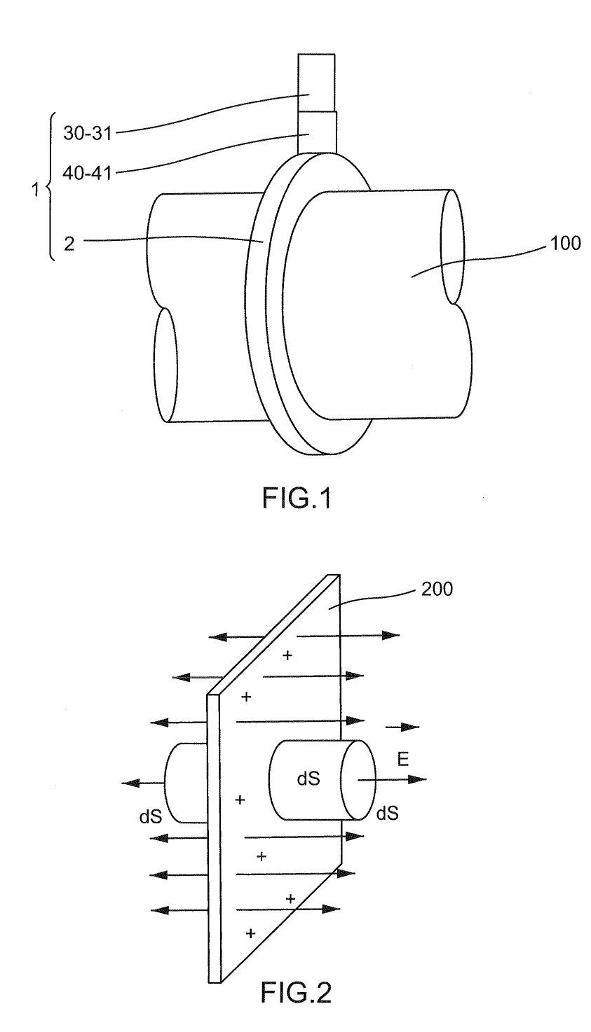

In conformity with what is set out in the invention and illustrated in the figures, the electric emission wheel 1, the objective of this invention patent (FIG. 1), is used to identify and/or monitor parameters, such as: speed, acceleration, rotations, positions, angles, and others of a rotating part 100, such as an axle or others particularly used in the automotive industry, this assembly 1 is the type generically consisting of: a sensitizing wheel or ring (tone wheel) 2, which is mounted around the rotating part 100 to be monitored; by a capacitive sensor 30, that has a sensor terminal 31 next to the sensitizing ring 2; and by means of sensitizing consisting of an electric field 40 present between the sensor terminal 31 and the sensitizing ring 2 and which undergoes interference from this, generating the useful signal for monitoring.

The usual material for making a tone wheel is carbon steel, which has the characteristic of an electrical conductor. In this case, the basic research was guided to evaluate if the intrinsic characteristic of this material can help in the solution to the problem of developing a sensitizing ring type device to emit an electric signal, which the capacitive sensor is capable of collecting and recognizing this electric signal.

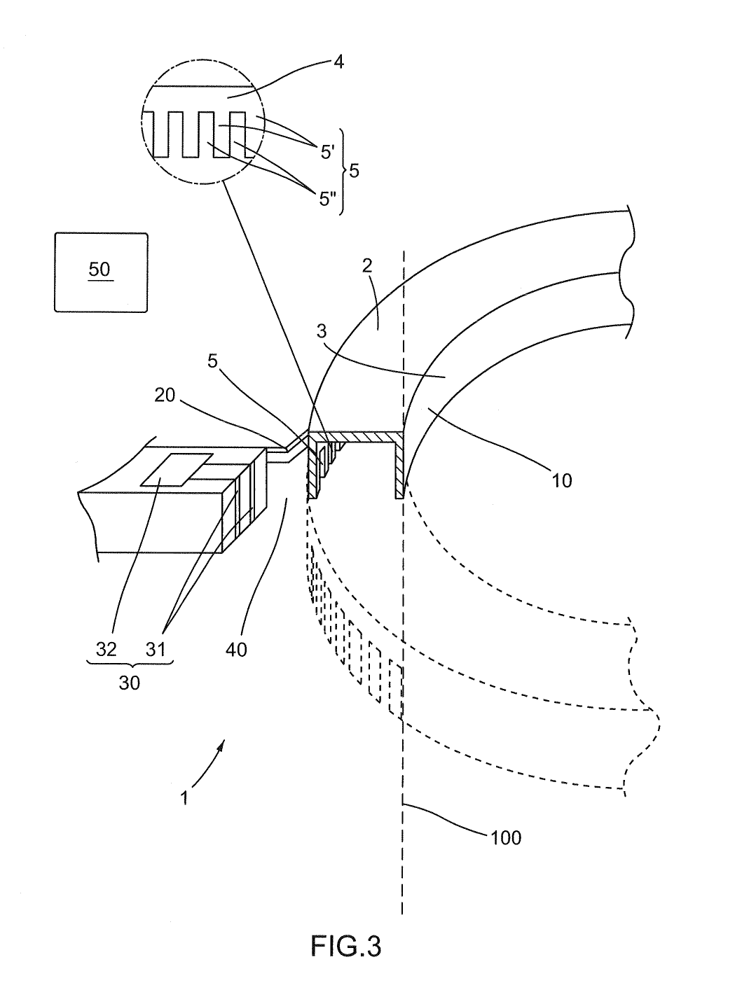

Within this, it was researched and proved that if a potential difference is used in contact, with for example, a metallic plate 200 (FIG. 2), free electric charges in the conducting materials tend to move to the external surface in the direction to create an opposite electric field (to try and cancel it) inside the material.

The electric field near the outside of a conductor is perpendicular to the surface and has the module σ/εo, where σ is the charge surface density and so is the permittivity.

The conceptual validation of this observation for this use was relatively simple. The first paradigm broken was to prove the need to insulate the motor metallic tone wheel, because this surface is “grounded” and as seen in the theory of physics, the Gauss surface is formed only when there is an insulated conducting material. However, in this case, when a potential difference is applied on a metallic tone wheel, it generates a temporary surface charge.

In the first studies, the temporary surface charge deposited on the surface was enough to sensitize the capacitive sensor. One advantage of this development relating to the PI 018100007784 patent application, as has already been mentioned is, therefore, the elimination of the need to use a special dielectric film on the metallic tone wheel and also the elimination of the electric induction process of this dielectric film which is made by special ionization processes or electric discharge processes in contact with the substrate.

Therefore, in agreement with the main objective of the invention, the objective of this present patent, the sensitizing ring 2 (tone wheel), of this invention, instead of planning to cover the special dielectric film and needing the electric induction process of this dielectric film by ionization or electric discharges in contact with the substrate conforming to the patent application mentioned above; this sensitizing ring 2, in this present invention, can have a geometry similar to the ring of the application and patent referred to above, but exploit the effect of an electric field 40 temporarily stored in the Gauss surface of the conducting material from which the ring is made and this electric field 40 emitted, by this sensitizing ring 2 or elements connected to this, a capacitive sensor 30 capable of “reading” this specific electric field 40.

The electric field 40 of the sensitizing ring 2 (metallic tone wheel insulated from the environment) can, in its turn, be charged by an external potential difference through an electric connection element 20 that has contact with the ring 2 taking into account that this charge will lose its effectiveness in some minutes and therefore it is necessary to constantly apply an external potential difference on the conducting material to re-introduce new surface charges and so eliminate the nullifying effect coming from the discharge phenomenon to the environment.

The capacitive sensors 30 available in the market and used in this invention, also known as proximity sensors are the type uses the concept, that when any “sensor” face approaches a body there is a variation in the dielectric behavior, that in its turn varies the quantity of charges of the capacitive element, causing a commutation of the sensor signal. By using the sensitizing ring 2 electrically charging, such as, the permanent dipole dielectric or electric wheel, was also changed to form the detection of the capacitive sensor 30, because this special sensitizing ring emits its own electric field 40, for the capacitive sensor to recognize the information. Therefore, the sensor element can become only an antenna 31, in other words, two parallel metallic wires would be enough to collect the electric signal and send to an electronic circuit to process the signal.

Possibilities of Making the Electric Emission Wheel Assembly

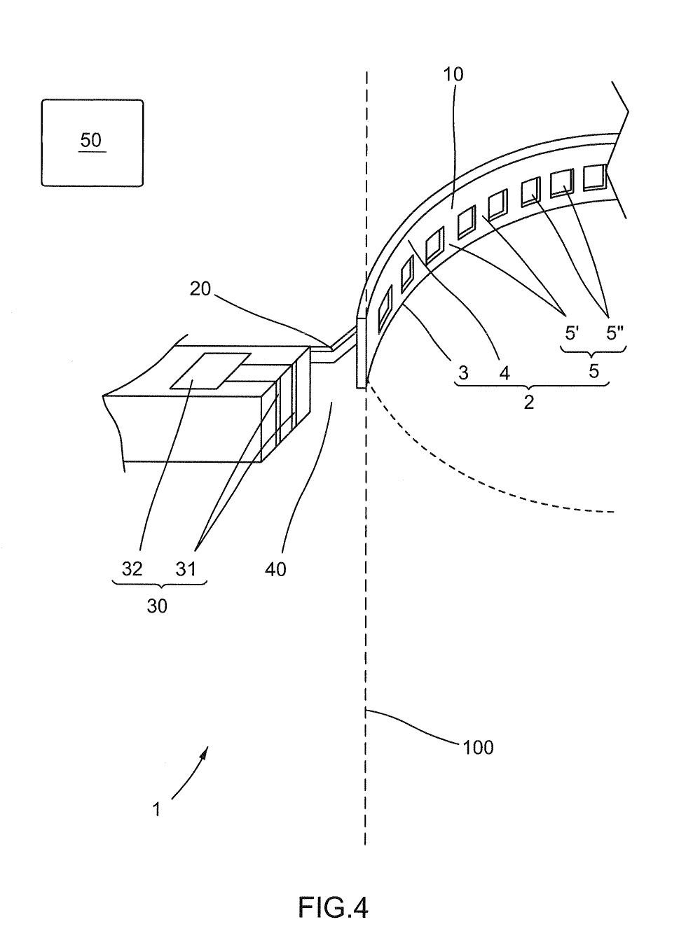

Considering the essential aspects of the invention described above, a possibility of making (FIG. 3), the electric emission wheel assembly essentially consists of: a sensitizing ring 2, mounted integrally around a rotating part 100 to be monitored, obtained from the electric conducting material, which has a “U” section defined by an internal surface 3 next to the part 100 and the external surface provided with an electric contact strip 4 which receives an external potential difference and the commutation strip 5 made of teeth 5′ and gaps between the teeth 5″, these teeth 5′ have the electric potential charged in the ring and the gaps 5″ have zero potential, providing the ON-OFF signals useful to the system; this assembly also made of: a galvanized electric insulation layer 10, positioned between the internal surface 3 of the sensitizing ring 2 and the rotating part 100 to be monitored, insulating in this way the ring 2 of the latter and all the assembly to which this part belongs; an electric connection element 20, joined in the middle that provides the external potential difference and transmits the supply voltage to the electric contact strip 4 of the sensitizing ring 2, temporarily storing in the Gauss surface this electric field 40 and turning this ring 2 and particularly its teeth 5′ emitters of the voltage received; this assembly also consists of a capacitive sensor 30 whose sensor terminal 31 is next to the commutation toothed strip 5 of the sensitizing ring 2, such that the signals provided by teeth 5′ (charged with electric potential) and gaps 5″ (zero electric potential) are collected by the capacitive sensor 30; and by the associated ECU 50 which receives and processes the emitted signals from the sensitizing ring 2 assembly and capacitive sensor 30 and generates appropriate control signals.

Detailing, the sensitizing ring 2 can be obtained from electric conducting material or electric conducting composite.

The potential supplied is greater than 40V, which can be set up inside the actual sensor 30 or from another source sent directly from the ECU 50.

The galvanized insulation 10 can be a resin or electrically insulating polymer.

The electric connection element 20 consists of a metallic material or electric conducting composites, chosen to transmit voltage from the external source to the ring 2 and resist the mechanical contact of this in movement.

The capacitive sensor 30 can be made of two metallic electrodes (antenna) 31 joined to a suitable electronic circuit 32.

Therefore, when functioning, the sensitizing ring 2 rotates in unison with the rotating part 100, making the teeth 5′ (charged with electric potential) and the gaps 5″ (with the electric potential discharged) pass successively past the sensor terminal 31 of the capacitive sensor 30, such that the teeth 5′ emit electric field samples that are collected by the sensor 30 and the gaps 5″ do not emit thus providing a suitable signal to the ECU.

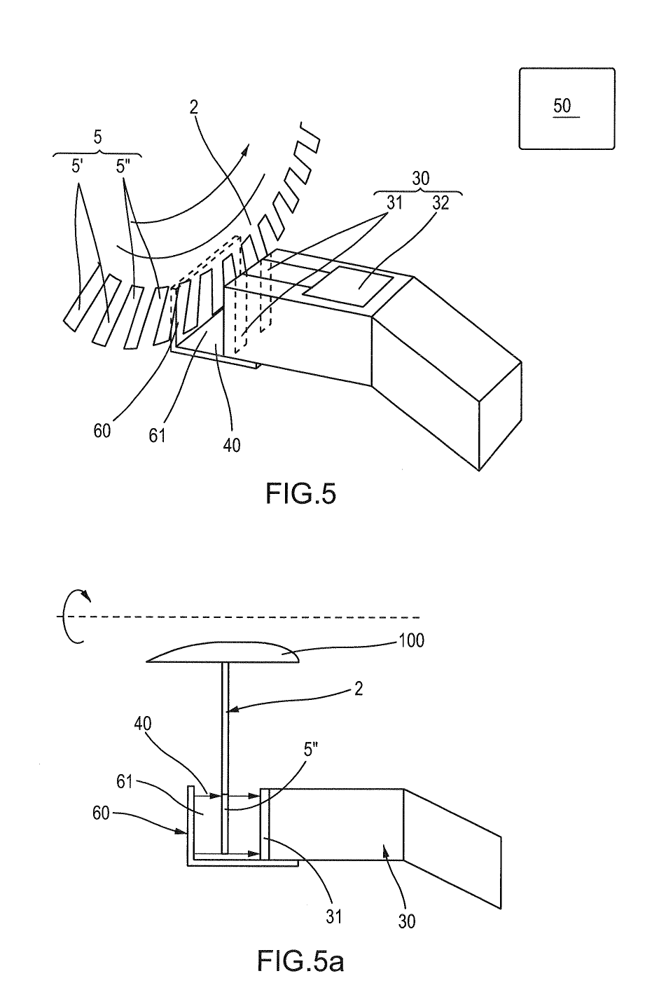

Another implementation possibility (FIG. 4), the sensor ring 2 is made of an axial arm which is next to the surface of the part 100 to be monitored which has a electric contact strip 4 and commutation strip 5 consisting of gaps between windows 5′ (charged with electric potential) and windows 5″ (zero potential), this ring also consists of a radial arm; this assembly also made of a galvanized electric insulation layer 10 positioned between the axial arm of the ring 2 and the surface of the part 100; an electric connection element 20 placed against the electric contact strip 4; and the capacitive sensor 30 whose sensor terminal 31 is next to the commutation strip 5 made of gaps between windows 5′ and windows 5″.

Therefore, this version is similar to the earlier version, nevertheless in this case it has a small distance between the emitting element and the zero potential element (because the windows 5″ are very near the shaft 100), so that a smaller external voltage can be used than in the first version.

The potential used in this configuration should be higher than 20V.

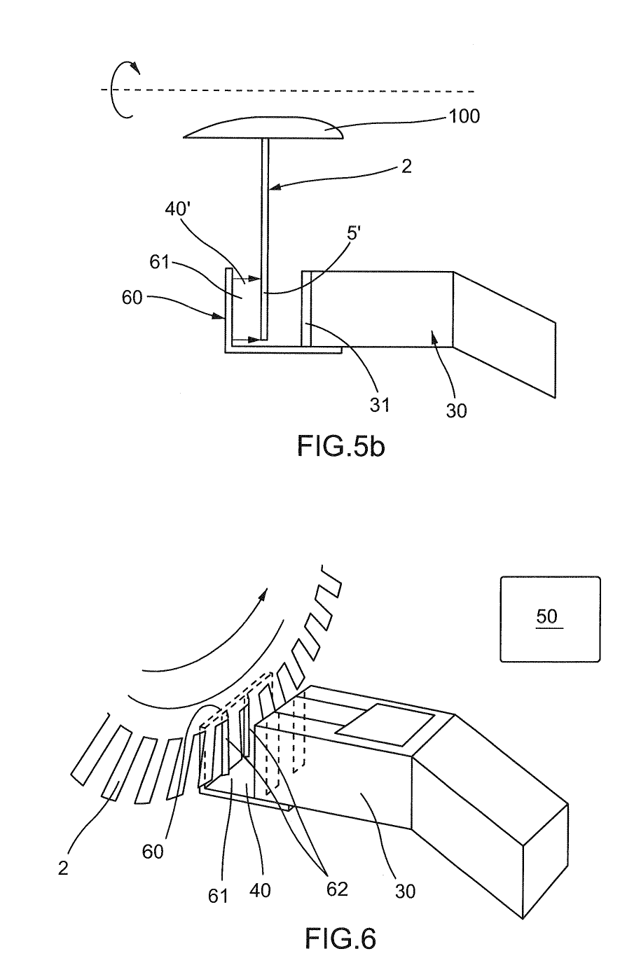

Another possibility of making the electric emission wheel assembly (FIG. 5) is prescribed as a capacitive sensor 30 with emission board 60.

This version essentially consists of: a sensitizing ring 2 provided with a commutation strip 5 consisting of teeth 5′ and gaps between the teeth 5″, which in this version, is not electrically insulated from the rotating part to be monitored 100, in other words, this sensitizing ring 2 is grounded, it is in electrical contact with the motor which part 100 belongs to and this sensitizing ring 2 is not directly supplied with an external electric voltage; and capacitive sensor 30 with voltage emitting board essentially consisting of: sensor terminals 31; additionally by an emitting board 60 of an electric conducting material, joined to the external electric voltage supply, parallel to the sensor terminals 31 and which maintains a gap 61 in relation to these; and an electric field 40 positioned in the gap 61 and formed by the emission between the emission board 60 and the sensor terminals 31; these teeth 5′ and gaps between the teeth 5″ of the sensitizing ring 2 are arranged in a manner to pass this electric field 40 emitted between the emitting board 60 and the sensor terminals 31, in a manner that when a tooth 5′ (FIG. 5b) or a gap between the teeth 5″ (FIG. 5a) is positioned between the emitting board 60 and the sensor terminals 31, providing, respectively interruption and passage of the electric field 40 to the sensor terminals 31, providing in this way for these intermittent samples 40′ of the electric field 40, which make useful signals for the system and are sent to the ECU 50, which appropriately processes them and emits control signals.

Detailing, also in this case, the sensor terminals 31 can be made of two metallic electrodes connected to a suitable electronic circuit 32.

The emission board 60 is metallic or an electric conducting composite material and is connected to a voltage source above 70V, consisting of an electronic circuit inserted in the actual sensor or this voltage is supplied by the ECU 50.

When functioning, the emission board 60, emits voltage supplied by sensor 30 or ECU 50, generating an electric field 40 between this board 60 and the sensor terminals 31 of the capacitive sensor 30 and when the teeth 5′ and gaps between the teeth 5″, of the sensitizing ring 2 connected to the rotating part 100, they pass through an electric field 40, providing, respectively, interruptions and passages of the electric field 40 to the terminals 31, so that an intermittent electric field 40′ reaches it, (ON-OFF) making useful signals for the system.

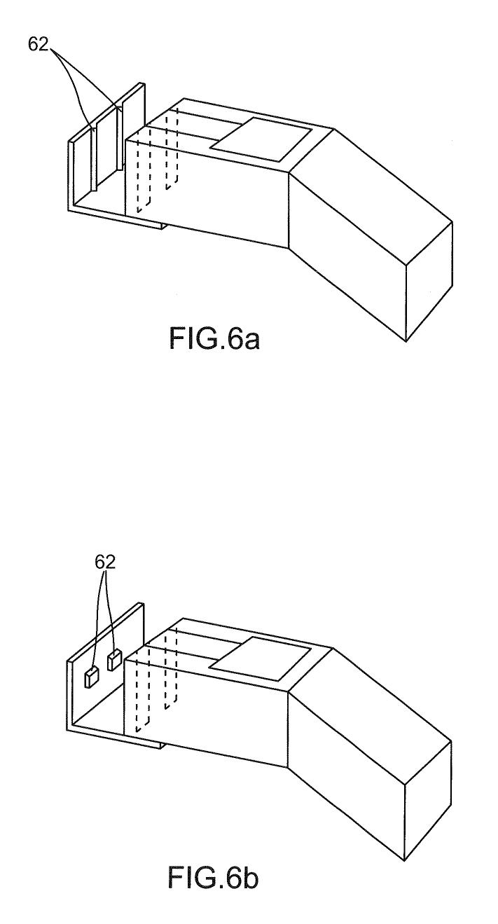

Another implementation possibility (FIG. 6), the electric sensitizing wheel assembly has substantially the same construction as the version before and incorporates the “point effect” that provides specific configurations and high intensity for the emitting electric field 40 of the invention.

In this case, when there is a potential difference applied to the emitting board or “shield point” 60′ provides the “point effect” which maximizes the electric field intensity 40 at the end of the shield “point”, once the electric field density (a) is inversely proportional to the surface area (A) (σ=Q/A) and the “point” has an extremely small area and the charges are constant, because it is working in an insulated system.

Therefore, in this version, the electric sensitizing wheel essentially consists of: a sensitizing ring 2 provided with a commutation strip 5 made from teeth 5′ and gaps between the teeth 5″, which is electrically insulated from the rotating part 100 to be monitored and not supplied directly with an external electric voltage; and a capacitive sensor 30 with a voltage emitting board with a “point effect”, essentially consisting of: sensor terminals 31; and emitting board with “point effect” 60′ obtained from electric conducting material, joined externally to the electric voltage supply, parallel and maintaining gap 61 in relation to the sensor terminals 31 and which has a face turned toward this gap 61 which has a profile with two surfaces in a sharp angle (points) 62 emitters of a high intensity electric field; and a high intensity electric field 40 positioned in gap 61 and formed by the emission between the points 62 of the emitting board 60 and the sensor terminals 31; these teeth 5′ and gaps between the teeth 5″ of the sensitizing ring 2 arranged to pass this high intensity electric field 40 emitting between the points 62 of the emitting board 60 and the sensor terminals 31, in a manner that when a tooth 5′ or a gap between the teeth 5″ positions itself between the points 62 of the emitting board 60 and the sensor terminals 31, providing, respectively, interruption and passage of an electric field 40 for sensor terminals 31, providing in this way intermittent samples 40′ of the electric field 40, which form the useful signals for the system and which are sent to the ECU 50, which appropriately processes and emits the control signals.

Detailing, also in this case, the sensor terminals 31 can be made of two metallic electrodes connected to a suitable electronic circuit 32.

The emitting board with “point effect” 60 is a metallic electric conductor or composite conductor and is connected to a voltage supply, which, in this version, can be less than the earlier version, due to the “point effect” which intensifies the electric field, this voltage is provided by an electronic circuit inserted in the actual sensor or this voltage is supplied by the ECU 50. The points 62 can be made by folded edges provisioned in the emitting board 60′ (FIG. 6a) or points strictly speaking by holes provisioned in the emitting board (FIG. 6b).

The function of this version is substantially the same as the earlier version, only the increase in the use of the larger electric field of greater intensity provided by the “point effect”.

Within the basic construction, described above, the electric sensitizing wheel, objective of this patent, can have changes regarding, materials, dimensions, constructive details and/or functional configuration and/or decorative, without losing the scope of the protection applied for.

1. Electric emitting wheel assembly to identify and/or monitor parameters of a rotating part (100), comprising a sensitizing wheel or ring (tone wheel) (2), mounted around and integral with the rotating part (100); a sensor (30), with sensor terminals (31) next to the ring (2); and a field (40) present between the terminals (31) and the sensitizing ring (2), wherein the sensitizing ring (2) (tone wheel) is obtained from electric conducting material, is mounted electrically insulated around the rotating part (100), is connected to an external voltage supply suitable for generating and temporarily storing in the Gauss surface of the conducting material so that the ring (2) makes an electric field (40), and has a commutation strip (5) selected to emit the electric field (40) with regular intermittence, generating a specific intermittent electric field (40)′; wherein the sensor is a capacitive sensor (30) configured to read the specific intermittent electric field (40) and send corresponding signals to an ECU (50) which receives and processes and emits control signals.

2. Electric emitting wheel assembly, in accordance with claim 1, wherein the sensitizing ring (2) has a “U” section defined by an internal surface (3) next to the rotating part (100) and an external surface provided with an electric contact strip (4) supplied with external electric voltage and commutation strip (5) comprising teeth (5)′ charged with electric potential supplied in the ring and gaps between the teeth (5)″ with zero potential; a galvanized electric insulation layer (10) is positioned between the internal surface (3) of the sensitizing ring (2) and the rotating part (100); an electric connection element (20) joined in the middle of the external voltage supply which is in contact and transmits electric voltage to the contact strip (4) of the sensitizing ring (2), temporarily stored in the Gauss surface of this electric field (40) and around this ring (2) and its teeth (5)′ emitter(s) of the received voltage; the capacitive sensor (30) has a sensor terminal (31) next to the toothed commutation strip (5) of the sensitizing ring (2), such that the signals provided by the teeth (5)′ with electric potential and gaps (5)″ with zero electric potential are collected by the capacitive sensor (30); and further comprising associated ECU (50) which receives and processes the emitted signals from the electric sensitizing wheel assembly.

3. Electric emitting wheel assembly, in accordance with claim 2, wherein a starting electric potential is supplied of around 25V and included inside the actual sensor (30) or of another source sent directly from the ECU (50).

4. Electric emitting wheel assembly, in accordance with claim 1, wherein the sensitizing ring (2) has an axial arm next to the surface of the part (100) to be monitored, the axial arm having an electric contact strip (4) and commutation strip (5) made of spaces between the windows (5)′ charged with electric potential and windows (5)″ with zero electric potential; a galvanized electric insulation layer (10) is positioned between the ring (2) axial arm and the surface of the part (100); an electric connection element (20) is placed against the electric contact strip (40; and the capacitive sensor (30) has a sensor terminal (31) next to the commutation strip (5) made of gaps between windows (5)′ and windows (5)″.

5. Electric emitting wheel assembly, in accordance with claim 4, wherein a starting electric potential is supplied of around 15V.

6. Electric emitting wheel assembly, in accordance with any one of claims 2, 3, 4, or 5 wherein the capacitive sensor (30) is made of two metallic electrodes (antenna) (31) integrated with a suitable electronic circuit (32).

7. Electric emitting wheel assembly, applied to identify and/or monitor parameters of a rotating part (100), comprising a sensitizing ring or wheel (tone wheel) (2), mounted around and integrated with the rotating part (100); a sensor (30) with sensor terminals (31) next to the ring (2); and a field (40) wherein the sensitizing ring (2) (tone wheel) is grounded with the rotating part (100), not directly connected to a voltage supply and which has a commutation strip (5); a capacitive sensor (30) with an emitting board includes terminals (31) and emission board (60) of an electric conducting material, integrated with a voltage source, parallel and maintains a gap (61) in relation to these sensor terminals (31); and the field (40) is positioned in the gap (61) and the emission board emitting (60) to the sensor terminals (31); the sensitizing ring (2) is positioned so that the commutation strip (5) passes and intermittently interrupts the electric field (40) and generates a specific intermittent electric field (40)′ which reaches the sensor terminals (31) of the capacitive sensor (30) appropriate for “reading” the specific intermittent electric field (40) and send corresponding signals to a ECU (50) which receives, processes and emits control signals.

8. Electric emitting wheel assembly, in accordance with claim 7, wherein the sensitizing ring (2) is provided with a commutation strip (5) made of teeth (5)′ and gaps between the teeth (5)″, the strip is mounted around and grounded to the rotating part to be monitored (100) and not directly supplied with external electric voltage; and the capacitive sensor (30) with the voltage emitting board, essentially made of sensor terminals (31); and additionally, the emitting board (60) is of electric conducting material, joined to the external electric voltage supply, parallel to the sensor terminals (31) and which maintains the gap (61) in relation to these; and the electric field (40) is positioned in the gap (61) and formed by the emission between the emission board (60) and the sensor terminals (31); the teeth (5)′ and the gaps between the teeth (5)″ of the sensitizing ring (2) are arranged in a manner to pass this electric field (40), in a manner that when a tooth (5)′ or gap between teeth (5)″ are positioned between the emitting board (60) and the sensor terminals (31), providing respectively, interruption and passage of an electric field (40) providing in this way a specific intermittent electric field (40)′, which is collected in the sensor terminals (31)″.

9. Electric emitting wheel assembly, in accordance with claim 8, wherein the emitting board (60) is metallic or electric conducting composite material and is connected to a supply with a 40V starting voltage, made of an electronic circuit inserted in the actual sensor or supplied by the ECU (50).

10. Electric emitting wheel assembly, in accordance with claim 7 or 8, characterized by incorporating “point effect” which provides specific configurations and high intensity to the emitting electric field (40); the emitting board has a face turned toward this gap (61) having a profile with two surfaces in a sharp angle (points) (62) emitters of a high intensity electric field; and a high intensity electric field (40) is positioned in gap (61) and formed by the emission between the points (62) of the emitting board (60) and the sensor terminals (31); the teeth (5)′ and gaps between the teeth (5)″ of the sensitizing ring (2) arranged to pass this high intensity electric field (40), in a manner that when a tooth (5)′ or a gap between the teeth (5)″ positions itself between the points (62) of the emitting board (60) and the sensor terminals (31), providing, respectively, interruption and passage of an electric field (40) providing in this way a specific intermittent electric field (40)′, which is collected by the sensor terminals (31)″.

11. Electric emitting wheel assembly, in accordance with claim 10, having a starting voltage used less than 40V.

12. Electric emitting wheel assembly, in accordance with claim 10, wherein the points (62) of the emitting board with “point effect” (60)′ are made of folded edges provisioned in the emitting board (60)′ or are provided by holes provisioned in the emitting board (60)′.

13. Electric emitting wheel assembly, in accordance with claim 8, wherein the sensor terminals (31) can be made of two metallic electrodes connected to a suitable electronic circuit (32).

14. Electric emitting wheel assembly, in accordance with claim 10, wherein the sensor terminals (31) can be made of two metallic electrodes connected to a suitable electronic circuit (32).
